(19) United States
(12) Patent Application Publication
(10) Pub. No.: US 2026/0034011 A1
(43) Pub. Date: Feb. 5, 2026

(54) CASKET TRANSPORT SYSTEM

(71) Applicant: STONEBROOKE EQUIPMENT, INC., Rosemount, MN (US)

(72) Inventors: Jerry D. Holman, Lakeville, MN (US); John S. Holman, Lakeville, MN (US); Pryce Z. Wigginton, Rosemount, MN (US)

(21) Appl. No.: 19/285,955

(22) Filed: Jul. 30, 2025

Related U.S. Application Data
(60) Provisional application No. 63/677,037, filed on Jul. 30, 2024.

(51) Int. Cl. A61G 21/00; B60P 1/02; B60P 1/64

(52) U.S. Cl. CPC A61G 21/00; B60P 1/02; B60P 1/6409; B60P 1/6427; B60P 1/6481; B60P 1/649

(57) ABSTRACT

A casket transport system for installation in a transport vehicle, and a method of loading eight or more caskets into the transport vehicle. The invention includes a plurality of shelves configured for mounting within a transport vehicle and receiving caskets in a lateral or sideways direction. A lift mechanism is mounted at the rear of the transport vehicle. The lift mechanism includes a base support member vertically movable along a vertical track between a lower position for loading caskets laterally and at least one raised position for moving the caskets laterally into the transport vehicle. At least one support arm is mounted to the base support member and configured to support a casket in a lateral direction as it is raised and lowered. An extension arm is pivotally mounted to the support arm and movable between a raised position and a lowered bridging position to facilitate sliding a casket laterally into the transport vehicle. In this way, at least eight or more caskets can be loaded into vehicle.

### RELATED APPLICATIONS

This application claims the benefit of U.S. Provisional Application No. 63/677,037 filed on Jul. 30, 2024, which is incorporated herein by reference in its entirety.

### TECHNICAL FIELD

This invention relates generally to transporting caskets and more particularly to an efficient system that can transport up to eight or more caskets. The invention includes vertically movable loading arms that move between the floor of the vehicle and spaced shelves. The shelves extend longitudinally and perpendicular to the vehicle walls. The caskets are loaded into the vehicle laterally onto the floor and the shelves.

### BACKGROUND OF THE INVENTION

Known casket transport devices for transporting caskets in a single vehicle are very complex. Some of these are very basic and use only one level, ie: the floor of the vehicle body. Others may use one or more levels made with various types of racking to hold the caskets, while others transport the caskets standing on their end. Some use a ramp to assist the driver in moving the caskets in and out of the vehicle, still others use an electric winch with a stranded cable to lift and lower the caskets that are quite unsafe. This system allows the operator to safely position the casket at any of one, two, or more loading levels while loading or unloading the casket without having to lift it manually or otherwise exert forces that could cause injury to the operator. It also allows a very efficient way to transport caskets as the system works equally as well for any length of vehicle body.

Another problem with known devices is that they are often limited to specialty vehicle bodies with casket handling methods that can expose the operator to undue stress from having to manually lift or force the caskets into position. These systems also present a risk of dangerous injuries to the operator from cable or lift breakage.

What is needed is a mechanism that has very few moving parts, is easy to maintain, and is less costly to manufacture. Also, what is needed is a mechanism that is easier to load and can load eight or more caskets into the transport vehicle, with the caskets being loaded laterally, or sideways, i.e, with the long sides of the casket being perpendicular to the sidewalls of the vehicle.

### SUMMARY OF THE INVENTION

In general terms, this invention provides a casket transport system for installation in a transport vehicle, and a method of loading eight or more caskets into the transport vehicle. The invention includes a plurality of shelves configured for mounting within a transport vehicle. In the disclosed embodiment, the shelves are mounted longitudinally in the transport vehicle, with a shelf on each side of the vehicle. There can be additional shelves, the one set shown is for illustration purposes. The caskets are loaded into the vehicle on the floor and onto the shelves with the caskets being loaded laterally to the longitudinal direction of the vehicle.

A lift mechanism is mounted at the rear of the transport vehicle, which includes a base support member vertically movable along a vertical track between a lower position for loading caskets onto the floor and at least one raised position for moving the caskets into the transport vehicle onto the shelves.

At least one pivotable support arm is mounted to the base support member and configured to support a casket as it is raised and lowered. An extension arm is pivotally mounted to the support arm and movable between a stored position and a bridging position to facilitate sliding a casket into the transport vehicle.

The lift mechanism includes a hydraulic actuator with a flexible drive. The flexible drive is connected to the base support to move the base support vertically along a vertical track.

These and other features and advantages of this invention will become more apparent to those skilled in the art from the detailed description of a preferred embodiment.

The drawings that accompany the detailed description are described below.

### BRIEF DESCRIPTION OF THE DRAWINGS

FIG. 1 is an end view of the casket transport system mounted within a transport vehicle.

FIG. 2 is a partial perspective view of a shelf mounted to the transport vehicle.

FIG. 3 is a further perspective view of a shelf mounted on the mounting rail and vertical mounting bracket.

FIG. 4 is a partial perspective view of the mounting rail and vertical mounting bracket mounted to the upper rail.

FIG. 5 is a partial perspective view of the vertical mounting bracket mounted to the lower rail.

FIG. 6 is a rear view of the transport vehicle and a partial view of the lift mechanism in the stored position.

FIG. 7 is a partial view of the lift mechanism arms partially opened.

FIG. 8 is a rear view of the transport vehicle and a perspective view of the lift mechanism with the lift arms fully opened.

FIG. 9 is a partial view of the lift mechanism with the extension arm extended for bridging between the main support arm and the slide tracks on the floor of the vehicle.

FIG. 10 is a partial view of the lift mechanism with the extension arm extended for bridging between the main support arm and the slide tracks on the shelf.

FIG. 11 shows the switch used to raise and lower the lift.

FIG. 12 is an end view of the casket transport system mounted within a transport vehicle, with a casket shown in phantom.

FIG. 13 shows the lift mechanism

FIG. 14 shows a partial view of the lift mechanism.

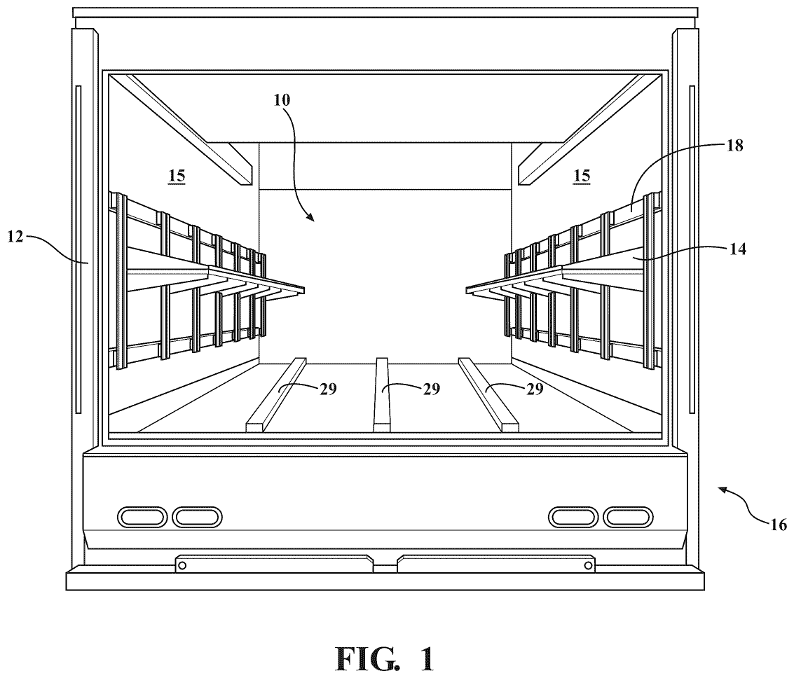

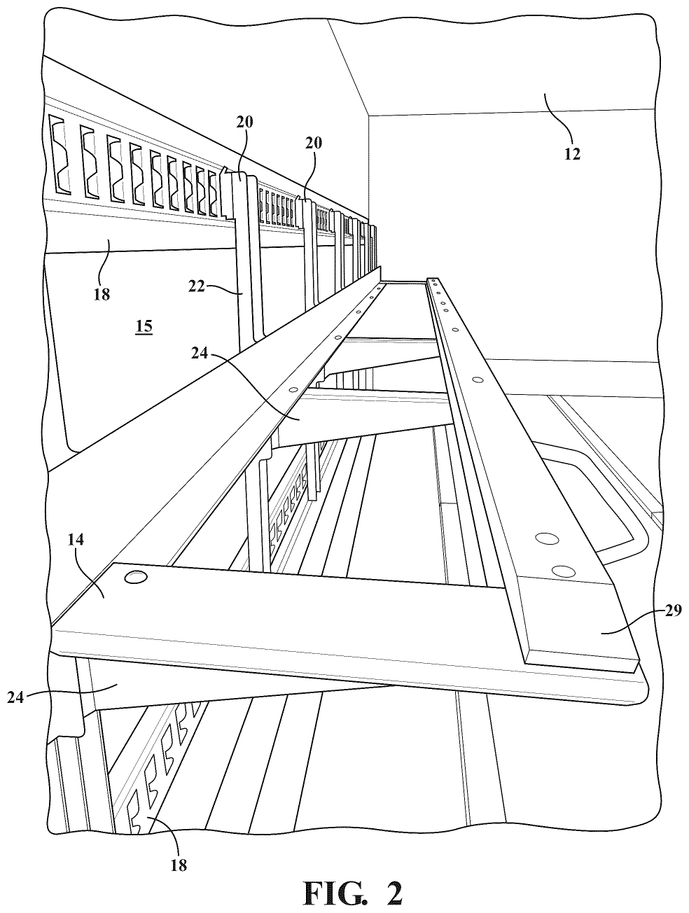

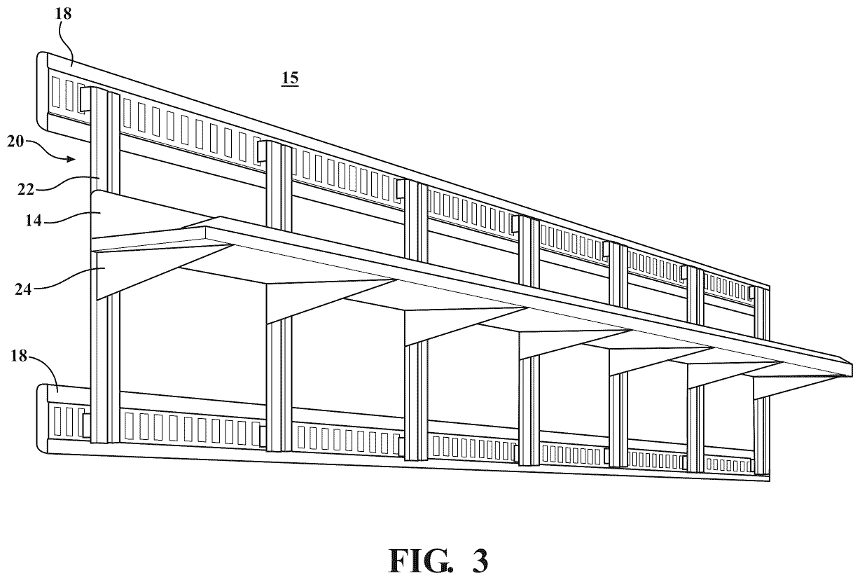

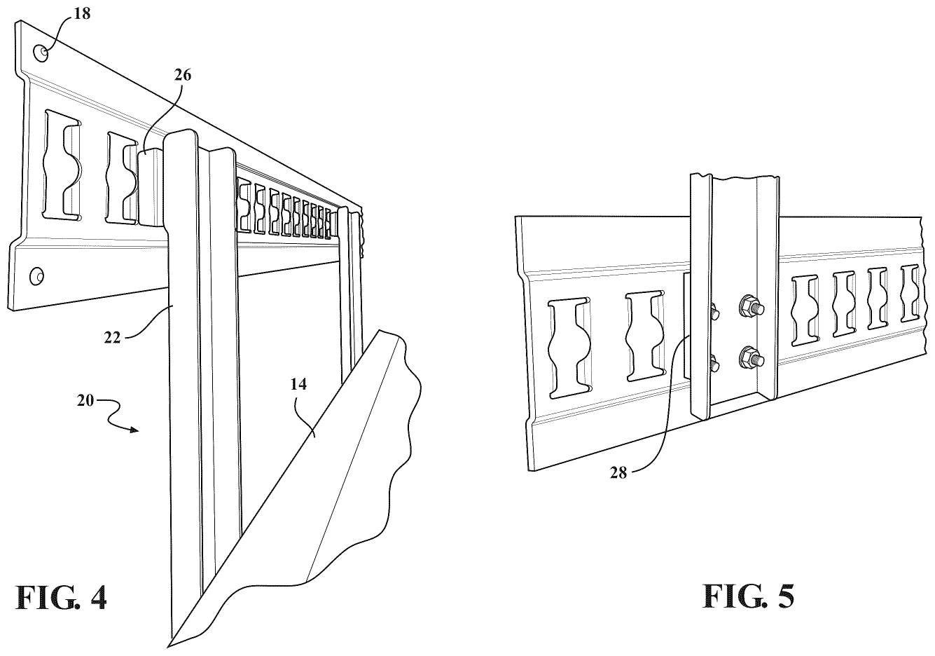

### DETAILED DESCRIPTION OF A PREFERRED EMBODIMENT

The casket transport system of the present invention is shown generally at 10 mounted in a transport vehicle 12. The casket transport system generally includes shelves 14 mounted to the interior walls of the transport vehicle 12 and a lift mechanism 16 mounted to the rear of the transport vehicle 12. One set of shelves 14 is illustrated. It will be understood that additional sets could be added for more caskets.

The shelves 14 are mounted facing one another and extend outwardly from the interior walls 15 of the transport vehicle 12. The shelves 14 are mounted on rails 18, which in the disclosed embodiment are E tracks. There are two sets of rails 18 extending longitudinally along the side walls 15 of the transport vehicle 12. As shown in the figures, the rails 18 are spaced apart and run parallel to one another. As will be appreciated by one of ordinary skill in the art, other types of rails could be used, and the invention is not intended to be limited to the use of E track rails.

Mounted to the rails 18 are vertical brackets 20 which support the shelves 14. Each vertical bracket 20 has a vertical brace 22 and a horizontal shelf support 24. An upper mount 26 is connected to the top of the vertical brace 22 and a lower mount 28 is connected to the bottom of the vertical brace 22. These mounts operatively connect to the rails 18. In the disclosed embodiment, the upper mount is welded to the top portion of the vertical brace and the lower mount 28 is bolted to the vertical brace. To install the vertical brace, the lower mount 28 is connected to the rail 18, then the upper mount 26 which is connected to vertical brace 22 is mounted to the rail 18. The vertical brace 22 is then bolted to the lower mount 28 as shown in the figures.

The horizontal shelf support 24 in the disclosed embodiment, has pre-formed holes for receipt of bolts which extend through the shelves 14 for connection to the horizontal shelf support 24. As shown in the figures, the shelves and floor have tracks 29 with poly slide strip surfaces for facilitating the easy sliding of caskets along the shelves 14. In use, the caskets are supported by the shelves 24, with the caskets mounted laterally or sideways within the transport vehicle 12.

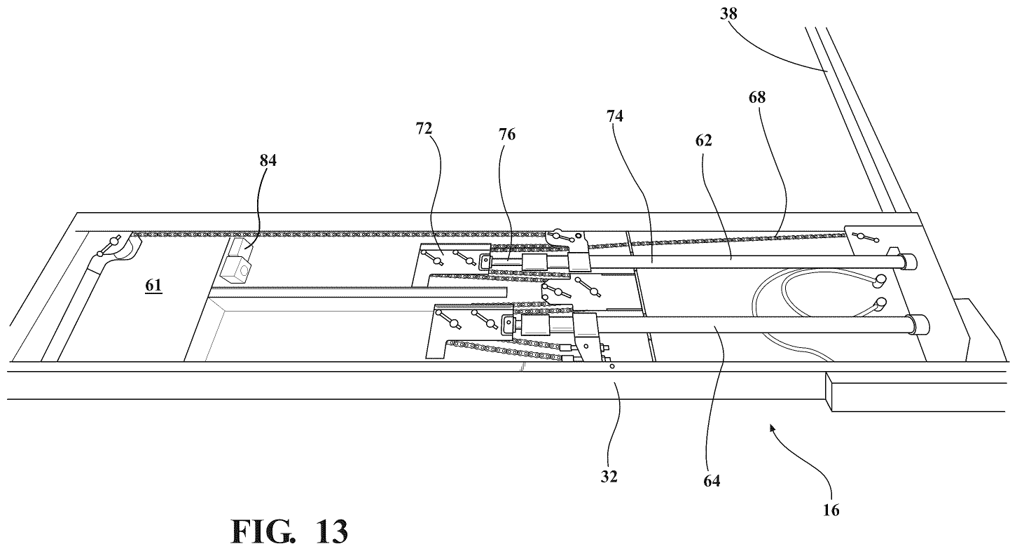

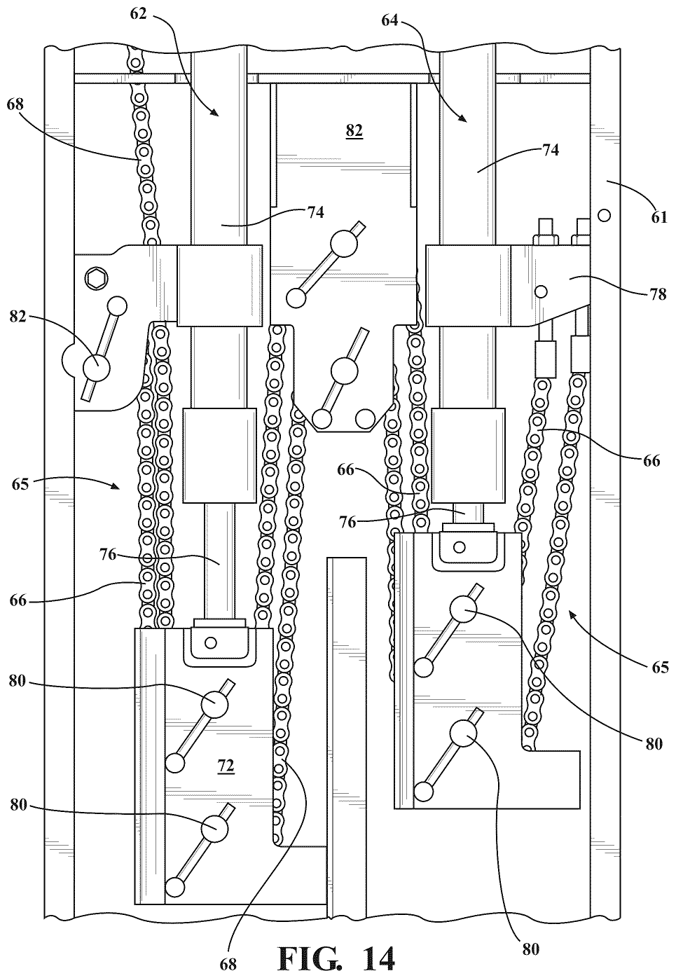

With reference to the FIGS. 13 and 14, the lift mechanism 16 will be described in detail. The lift mechanism includes a base support member 32, which extends laterally across the rear of the transport vehicle 12. The base support member 32 is mounted to a bracket 34, that rides within a vertical track 38.

The disclosed lift mechanism 16 is mounted within a housing 61 at the bottom of the vehicle. Lift mechanism 16 in the disclosed embodiment includes a pair of hydraulic cylinders 62 and 64, which are operatively connected to a 12 Volt electric over hydraulic pump (not shown), that operatively engage a flexible element shown generally at 65, which in the disclosed embodiment includes two flexible members 66 and 68, which are shown as chains. It will be understood by those of ordinary skill in the art that the flexible members 66 and 68 could be cables, belts, etc., instead of the chains. One of the flexible elements 68 is connected to the bracket 34. The other flexible element 66 acts as a balance to balance the two cylinders 62 and 64. The cylinders 62 and 64 extend, to raise the bracket 34 and retract to lower the bracket 34. Each of the hydraulic cylinders 62 and 63 include a body 74, a rod 76, and a head 72.

The flexible elements 66 and 68 are each fixed at mount 78 and extend around the heads 72 at the end of the rod 76 of the body 74. The head 72 has two spaced pulleys 80. The flexible element 68 is connected to the platform 34 through a series of guide pulleys 82. The flexible element 66 is connected at 84 and is also guided through guide pulleys 82.

When the cylinders 62 and 64 are extended, the flexible elements 66 and 68 raise the bracket 34, and when cylinders 66 and 68 are retracted, the flexible elements 66 and 68 lower the bracket 34. In the disclosed embodiment, a control switch 88 operates the cylinders 66 and 68 to raise and lower the bracket. An indicator light 90 is shown, which indicates when the lift is operational. The control switch 88 is shown mounted to the lift mechanism 16 adjacent to the step 92.

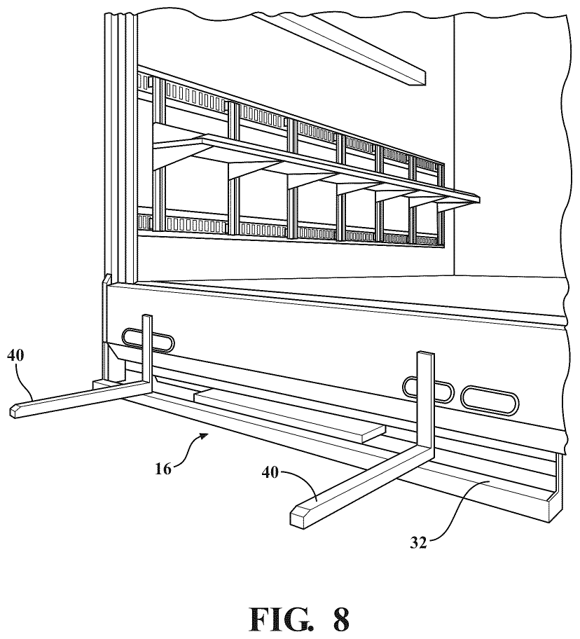

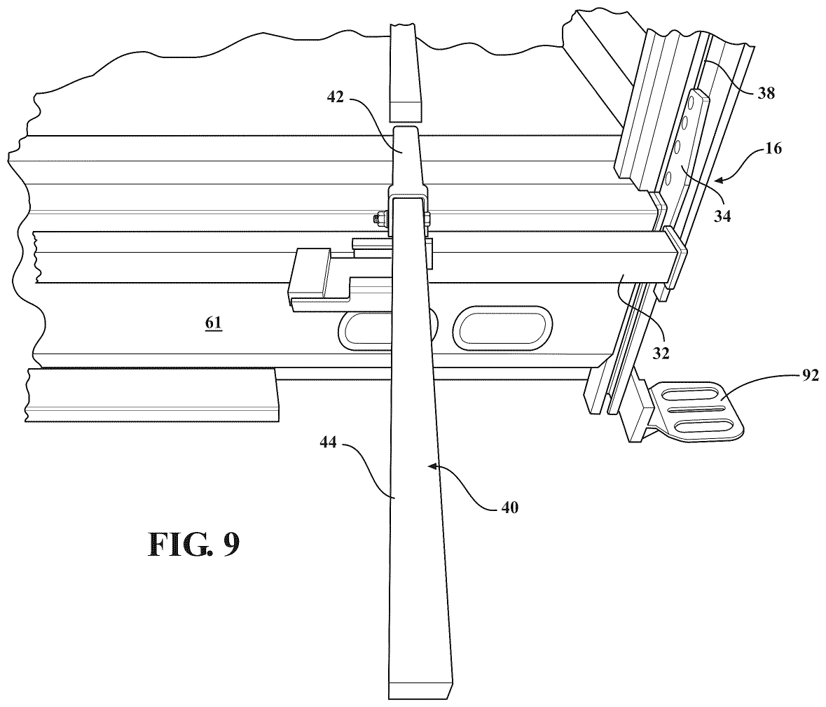

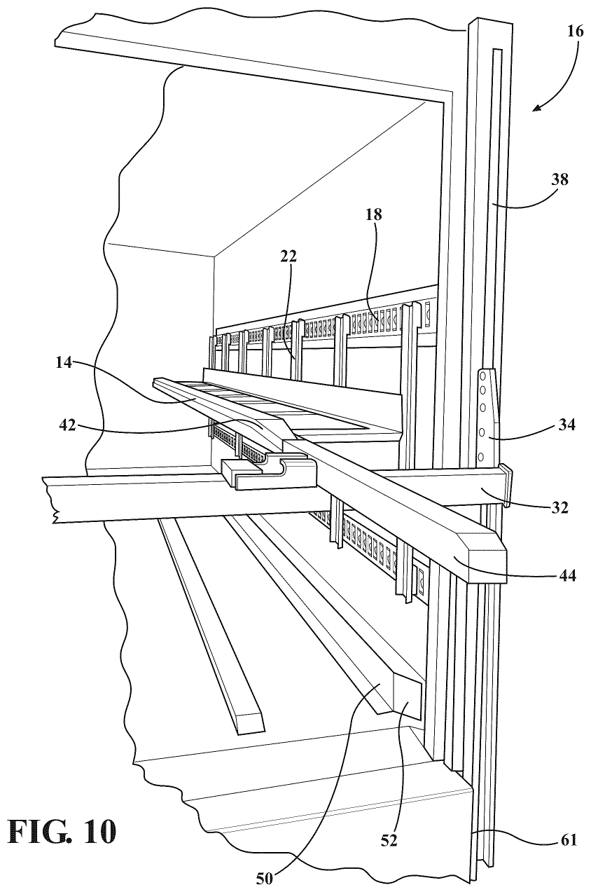

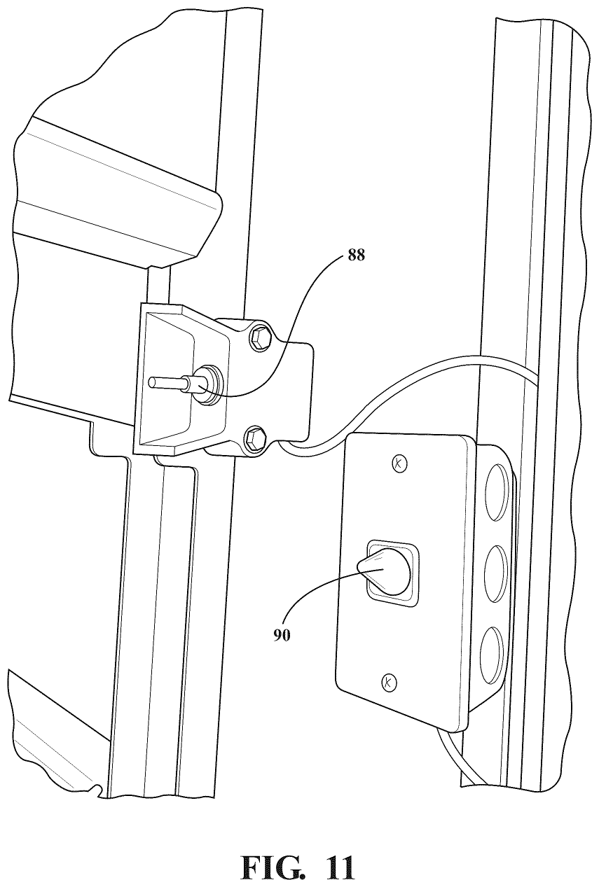

The lift mechanism 16 also includes support arms 40 that are mounted to the base support member 32. As illustrated, the support arms are mounted upon a bracket and bolt 37, which allows both connection of the support arms to the base member 32 while at the same time allowing the support arms 40 to pivot. It will be appreciated by those of ordinary skill in the art that the support arms 40 don't have to pivot but could telescope, or be detachable, etc. In FIG. 8, the support arms 40 are shown in their folded stored position. In FIG. 9, the support arms are shown pivoted at about a 45° angle. The extension arm 42 is shown raised with respect to the main support arm 44. The extension arm is pivotally mounted to the main support arm 44 through a pivot bracket 46. With reference to FIG. 10, the support arms 40 are shown fully pivoted which is the position for loading the caskets.

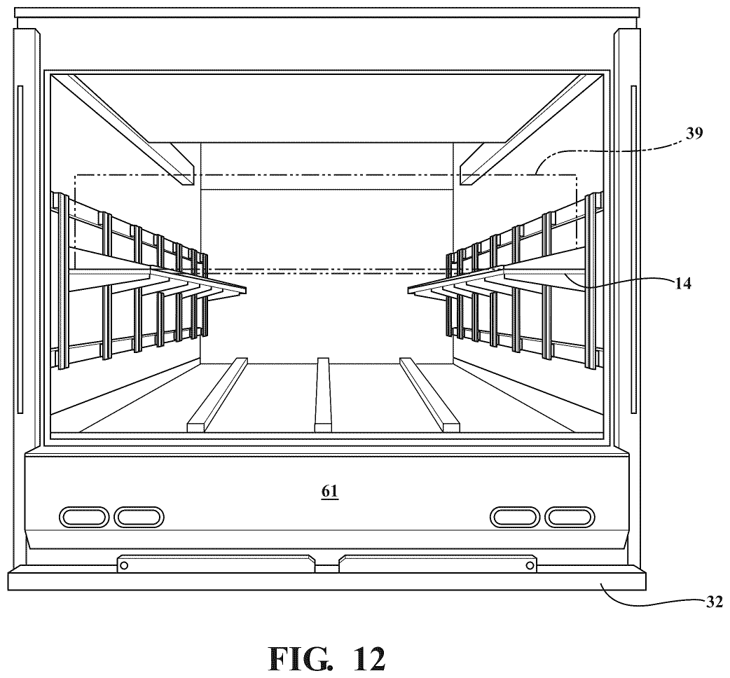

When fully pivoted, caskets can easily be loaded onto the support arms 40 and the extension arm 42 acts as an end stop. Once the casket is loaded, the lift mechanism 16 is operated. In the disclosed embodiment there's a control switch mounted to the interior wall 15 of the vehicle. The lift mechanism 16 raises the loaded casket to either the floor level as shown in FIG. 11 or the shelf level as shown in FIG. 12. As can be seen, when the lift mechanism reaches either the floor level or the shelf level, the extension arm 42 is lowered to create a bridge between the main support arm 40 and the interior track on the floor or the shelf. This facilitates the easy sliding of the casket into the transport vehicle. Again, the caskets are loaded laterally onto the lift mechanism 16 and slid into the transport vehicle laterally, so that they're positioned laterally on the shelves 14 and the floor of the vehicle. A casket 39 is shown in phantom in FIG. 12 to illustrate the lateral loading.

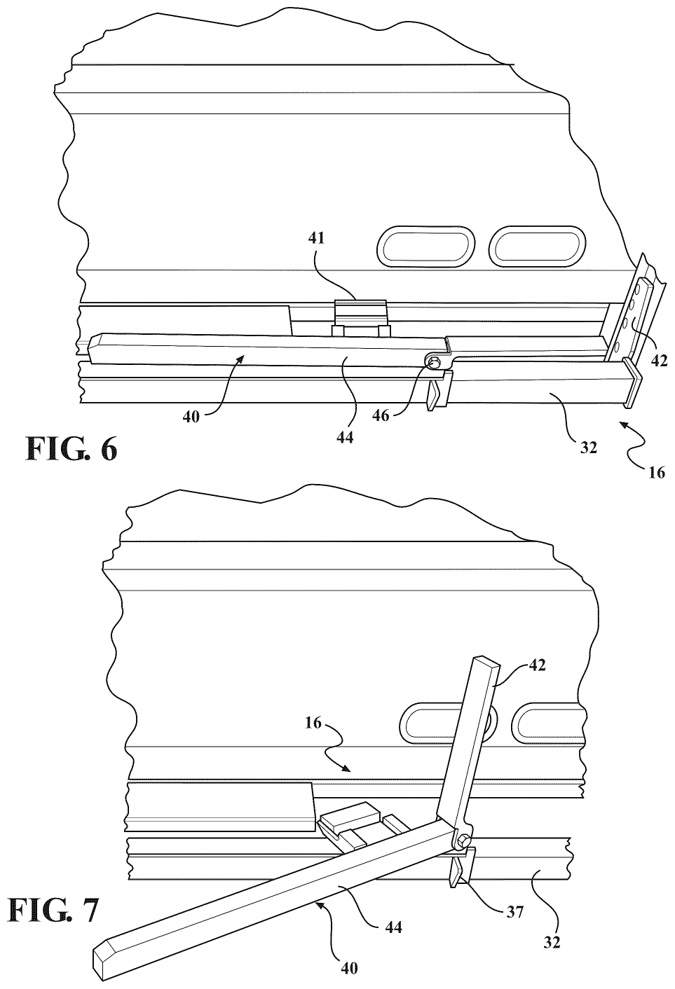

In FIG. 6, a rubber block 41 is shown. The rubber block 41 locks the arms 40 in their folded stored position so that they cannot swing out. The lift mechanism 16 is lowered to the bottom. The arms 40 are folded in, in line with the base member 32. The lift 16 is then raised to squeeze down on the rubber block 41.

As shown in FIG. 10, there is a side rail 50 mounted adjacent to the floor of the transport vehicle to facilitate the guiding of the caskets into the transport vehicle when on the floor. The side rail 50 has a sloped wall or angled front wall 52 that guides the casket into the vehicle along the rail 50.

The casket transport system of the present invention has been shown with respect to a transport vehicle that can receive up to ten caskets, five loaded onto the floor of the vehicle and five loaded onto one set of shelves 14. Larger vehicles can accommodate a greater number of caskets, depending on the vehicle's length, and can carry more shelves, such as three levels of caskets, the floor plus two shelves.

It will be understood by those of ordinary skill in the art that the present invention provides a very effective and efficient transport system for transporting caskets. The system is designed for retrofitting existing transport vehicles of various types. In addition to being easily installed within an existing transport vehicle without the need for any modifications to the vehicle, other than the installing of the transport system itself, the present invention also provides a transport system that can be easily removed and reinstalled in another vehicle as desired.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded by this invention can only be determined by studying the following claims.

We claim:

1. A casket transport system for installation in a transport vehicle, comprising:
a plurality of shelves configured for mounting within a transport vehicle; said shelves are configured to receive caskets in a lateral direction;
a lift mechanism mounted at the rear of the transport vehicle, including a base support member vertically movable along a vertical track between a lower position for loading caskets and at least one raised position for moving the caskets into the transport vehicle;
at least one pivotable support arm mounted to the base support member and configured to support a casket;
whereby caskets can be loaded onto said support arm and raised vertically for loading onto a transport vehicle.

2. The casket transport system of claim 1, further including a plurality of spaced mounting rails secured to the interior sidewalls of the transport vehicle;
a plurality of brackets removably connected to the mounting rails, each vertical bracket including a vertical brace; and a horizontal shelf support extending perpendicularly from the vertical brace;
said shelves being mounted to said horizontal shelf supports.

3. The casket transport system of claim 2, wherein the mounting rails are E-track rails extending longitudinally along the sidewalls of the transport vehicle.

4. The casket transport system of claim 1, wherein the shelves include integrated sliding tracks having poly slide strip surfaces for facilitating movement of the caskets.

5. The casket transport system of claim 1, wherein the upper mount of the vertical bracket is welded to the vertical brace, and the lower mount is bolted thereto.

6. The casket transport system of claim 1, wherein the vertical movement of the lift mechanism is driven by a flexible member operatively connected to a hydraulic cylinder powered by a 12-volt electric over hydraulic pump.

7. The casket transport system of claim 1, wherein the support arms of the lift mechanism are pivotable between a stored vertical position and an extended horizontal position.

8. The casket transport system of claim 1, further comprising a block positioned to lock the support arms in the stored position when the lift mechanism is in a lowered configuration.

9. The casket transport system of claim 1, further including an extension arm mounted to said support arm and configured to form a bridge between the support arm and either a shelf or the floor of the transport vehicle.

10. The casket transport system of claim 1, wherein the system is configured to accommodate eight or more caskets, with five positioned on the floor and five on the shelves.

11. The casket transport system of claim 1, wherein the side rail includes an angled front wall to facilitate guided entry of the casket during loading.

12. A method of transporting caskets using a modular transport system installed in a transport vehicle, the method comprising:
(a) mounting a plurality of shelves to opposing interior sidewalls of the transport vehicle using vertical brackets secured to mounting rails;
(b) positioning caskets laterally on the shelves, each shelf including sliding tracks to facilitate movement of the caskets;
(c) providing a lift mechanism mounted to a rear portion of the transport vehicle, the lift mechanism including:
(i) a vertically movable base support member;
(ii) at least one support arm mounted to the base support member; and
(d) placing a casket onto the at least one support arm of the lift mechanism in a lateral orientation;
(e) actuating the lift mechanism to raise the casket to a desired level corresponding to either the floor or a shelf level; and
(f) sliding the casket laterally from the lift mechanism into the transport vehicle.

13. The method of claim 12, further comprising securing the vertical brackets to E-track mounting rails extending longitudinally along the sidewalls of the transport vehicle.

14. The method of claim 12, further including pivoting the at least one support arm of the lift mechanism between stored and use positions.

15. The method of claim 14, including the step of engaging a rubber block to lock the support arms in the stored position.

16. The method of claim 12, further including the step of providing an extension arm movably mounted to the at least one support arm and movable to a bridging position; moving the extension arm between a stored position to a bridging position to form a bridge between the support arms and either the shelves and floor after the lift mechanism reaches the shelf or floor level.

17. The method of claim 12, further comprising guiding the casket during loading using a side rail.

18. The method of claim 17, wherein the side rail includes an angled front wall to engage and align the casket with the loading path.

19. The method of claim 12, wherein up to eight or more caskets are transported in the transport vehicle, with five supported on the floor and five on the shelves.

20. The method of claim 12, further including the step of providing said lift mechanism with a flexible drive member operatively connected to a hydraulic cylinder.
